(19) United States
(12) Patent Application Publication
(10) Pub. No.: US 2021/0323142 A1
(43) Pub. Date: Oct. 21, 2021

(54) GRIPPER HAVING AN INTERCHANGEABLE HEAD, AND TOOL COMPRISING SAME

(71) Applicant: WIBEMO S.A., Rebeuvelier (CH)

(72) Inventor: Clovis CHETELAT, Vicques (CH)

(21) Appl. No.: 17/271,962

(22) PCT Filed: Aug. 29, 2018
(86) PCT No.: PCT/EP2018/073264

§ 371 Date: Feb. 26, 2021

(51) Int. Cl. B25J 9/08; B25J 15/00

(52) U.S. Cl. CPC B25J 9/08; B25J 15/0052

(57) ABSTRACT

Disclosed is an interchangeable gripper head including: a body defining a longitudinal axis, including a first end intended to be fitted into a nut and a second, free end provided with sectors capable of elastic deformation in a radial direction and intended to receive a removable head; a thrust pin mounted so as to slide along the longitudinal axis inside the body, in a first direction under the effect of a driving force transmitted through the nut by a kinematic connector and in a second direction under the effect of a spring member; and lugs integrally mounted and in a regular angular arrangement on the thrust pin and protruding radially from the surface of the thrust pin through the body of the gripper. The lugs are fixedly arranged in a longitudinal and radial position on the thrust pin by a fixing unit.

### TECHNICAL FIELD

The present invention relates to the field of machining. It relates, more particularly, to a gripper with an interchangeable head adapted to be used in a machining device, and in particular, a lathe.

### STATE OF THE ART

Tools are known that are equipped with interchangeable gripper heads for clamping from the outside. These tools consist of a spindle and a gripper with a body and a thrust pin as mentioned above. A socket is movably mounted outside the body, between the body and the spindle. The gripper has a clamping cone which, when the socket moves, allows the diameter of the gripper to be reduced for clamping from the outside. This type of gripper is known to a person skilled in the art as an F-type gripper.

However, this type of tool and gripper is not suitable for machining certain complex workpieces, especially when a workpiece has to be machined along its entire length without being able to hold the workpiece at both ends. In such cases, it is necessary to take the workpiece from the other side, if doing so be possible, which causes concentricity problems and can also mark previously machined parts of the workpiece.

There are grippers that can be used to hold a workpiece from the inside, i.e., by inserting the end of the gripper into a cavity in the workpiece The Applicant proposed such a gripper in the patent EP ______. However, the machining accuracy of workpieces held with such grippers tends to deteriorate over time, in particular following service and/or dismantling operations of the gripper, due to play and offsets induced by dismantling/reassembly between the modular parts of the gripper, in particular the conical support elements of the gripper in the spindle of the machining device.

The aim of the present invention is to remedy such problem.

### DISCLOSURE OF THE INVENTION

To achieve this goal, the invention proposes a gripper with an interchangeable head comprising:
a body defining a longitudinal axis, comprising a first end intended to be fitted in a nut and a second, free end provided with sectors capable of elastic deformation in a radial direction and intended to receive a removable head,
a thrust pin mounted so as to slide along said longitudinal axis inside said body, in a first direction under the effect of a driving force transmitted through the nut by a kinematic connection means and in a second direction under the effect of a spring member,
a plurality of lugs integrally mounted in a regular angular arrangement on the thrust pin and protruding radially from the surface of said thrust pin through the body of the gripper.

Characteristically and advantageously, the gripper of the invention is characterised by the fact that the said lugs are fixedly arranged in a longitudinal and radial position on the thrust pin by way of a fixing means.

The provision of an fixing means for the lugs on the thrust pin advantageously provides an invariable reference for the positioning and for the assembly for the said lugs on the thrust pin, which makes for a singular improvement in the precision of the gripper being used. This reference guarantees, even when the gripper is being serviced and dismantled, that the lugs will always be equidistant from the ends of the body of the gripper and in the same radial position on the thrust pin, which is not possible with the simple screw fastening of grippers of the prior art. Machining accuracies of around 1/100th of a millimetre are thus achieved on the machined workpieces, whereas with the grippers of the prior art, this accuracy was at best 5/100ths.

In one embodiment, the said body comprises oblong openings through which the lugs (4) extend protruding from the thrust pin.

In one embodiment, the fixing means is a peg driven into a blind hole formed in said lugs and adapted to be inserted into a hole of corresponding diameter in the thrust pin.

In one embodiment, the said sectors delimit a cradle for assembly, without any play, of a gripper head comprising ‘n’ deformable sectors capable of being secured to the sectors of the body of the gripper by screwing.

In one embodiment, the said lugs are fixed on the thrust pin on flats formed in the head of the thrust pin.

In one embodiment, the said lugs are locked in rotation on the thrust pin by screwing into a hole drilled in the said thrust pin.

In one embodiment, the holes for fixing and screwing the said lugs are drilled parallel to each other from one external surface of said flats and these same holes open into an internal cavity of the thrust pin.

In one embodiment, said lugs comprise a screw tab comprising a through-hole for screwing on the thrust pin and a tooth integral with said screw tab and having an external support plane inclined at an angle with respect to a common base of the screw tab and the tooth.

In one embodiment, the said blind hole for driving in the peg is drilled in the tooth along an axis parallel to that of the screwing hole.

In one embodiment, the mounting cradle of the detachable head delimited by the sectors of the body comprises a flat inner guide surface and the detachable head a mounting sleeve with a flat outer surface and a diameter equal to the inner diameter of the mounting cradle.

The invention also relates to a machining device comprising a gripper with an interchangeable head as previously defined.

### BRIEF DESCRIPTION OF THE DRAWINGS

Other details of the invention will become clearer on reading the following description, with reference to the attached drawings in which:

FIGS. 1 and 2 are respectively perspective and longitudinal section views of a pair of a gripper according to the invention, and

FIGS. 3A and 3B are top and longitudinal section views, respectively, of a tapered tooth lug for the gripper according to the invention;

FIGS. 4 to 6 are, respectively, top, longitudinal and front views of a thrust pin of the gripper according to the invention;

FIGS. 7 and 8A, 8B are perspective, side and cross-sectional views of a gripper with interchangeable head of the invention.

### EMBODIMENT(S) OF THE INVENTION

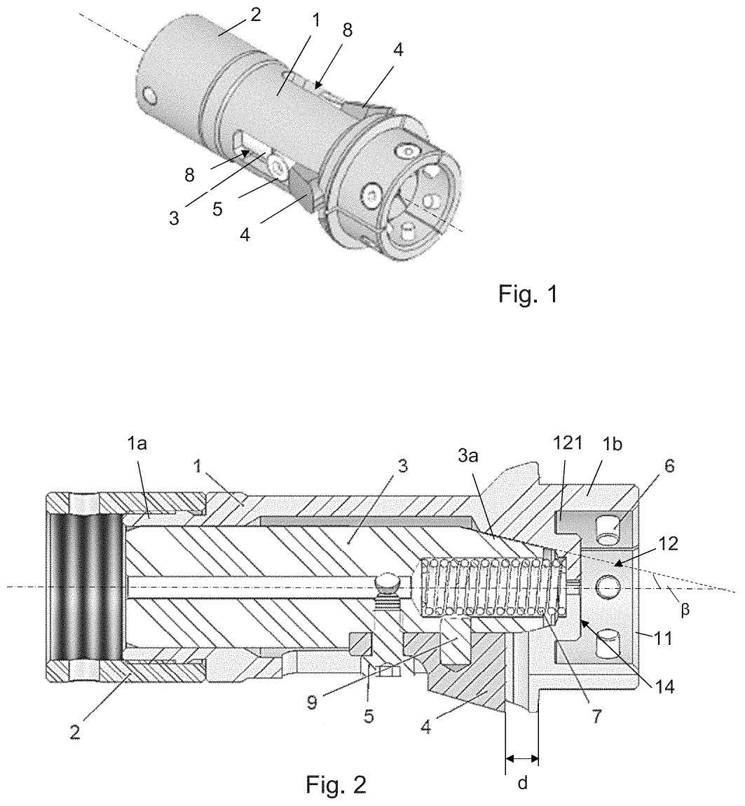

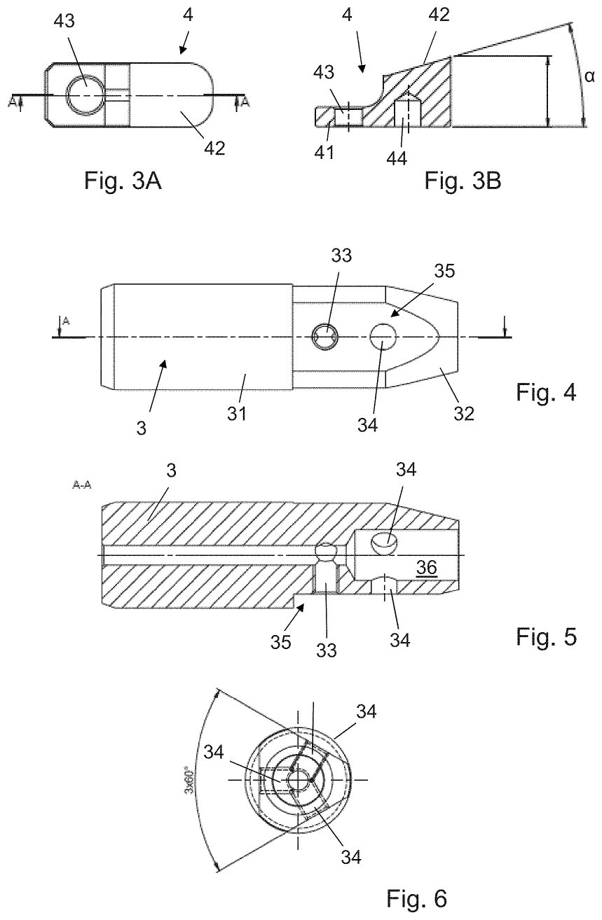

FIGS. 1 and 2 show a gripper with an interchangeable head according to the invention in a preferred embodiment. This gripper consists of a cylindrical body 1, defining a longitudinal axis shown as a dashed line in these figures. At a first end 1a of the body 1, the gripper is arranged to be fitted in a spindle of a tool or machining device or machine tool. A person skilled in the art knows how such a gripper can be inserted into a machine tool in this way, without there being any need to describe this in detail. At this end 1a the body 1 is integral with a nut 2, used, first, to connect the gripper to a said machine tool and, second, to guide and position the body 1.

The wall of body 1 is pierced with oblong openings 8, oriented longitudinally along generatrixes parallel to the longitudinal axis of body 1. In the example shown, the wall of body 1 is advantageously pierced with three openings 8, evenly distributed around the body 1. The role of these openings 8 will be made clear later.

The body 1 is also split at its second end 1b, along the longitudinal axis, so as to define sectors 11 capable of elastic deformation in a radial direction. The slots are advantageously made in the extension of the openings 8.

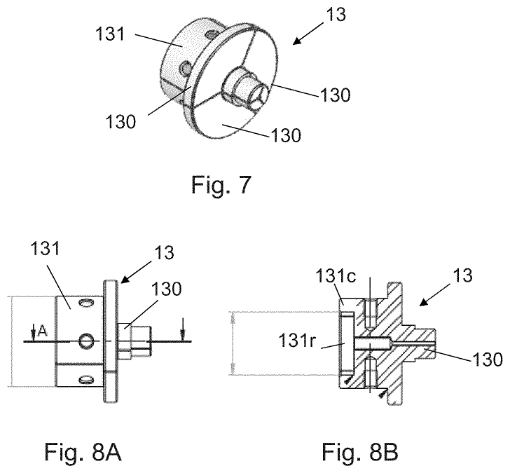

At its second end 1b, which is free when the gripper is inserted into the spindle of a machine tool, the body 1 comprises a housing 12 intended to receive an interchangeable clamping head 13, as shown in detail in FIGS. 7 to 8B. The housing 12 is preferably cylindrical in shape. It is designed to receive the clamping head 13, whose diameter is adjusted to fit into the housing 12. The head 13 consists of an insertion sleeve 131 in the housing 12 and a flange 13 to rest on the free end of sectors 11 delimiting the housing 12. The sleeve 131 has an external cylindrical surface with a diameter equal to the internal diameter of the housing 12 delimited by the internal walls of sectors 11, in order to guarantee a play-free fitting of the head 131 into the body 1 of the gripper.

As shown in FIG. 2, the housing 12 has a groove 121 at the bottom, in the centre of which a plate or stud 14 is formed. In a complementary manner, the head 13 comprises, as shown in FIG. 8B, a collar 131c at the end of the sleeve 131, said collar 131c being intended to be inserted without play into said groove 121 of the housing 12 and delimiting a recess 131r of a shape complementary to that of the stud 14 such that the said stud 14 penetrates said recess when the sleeve 131 is fitted into the housing 12. Thus, the head 13 is perfectly wedged in position in the housing by a double male-female fixing of its sleeve collar 131 in the groove 121 of the housing and of the stud 14 of the housing in the sleeve recess 131r.

Thus, the head 13 is shaped and dimensioned so that it also rests on the bottom of the housing 12 and against the edges of sectors 11 and is interchangeable, and therefore removable from the body 1 of the gripper since it can be simply inserted or removed from the housing 12. However, in order to ensure that the head is held in place when the gripper is in use, it is anchored to the body 1 by means of radial screws 6 inserted in holes provided for this purpose in the sectors 11 and the head 13.

The clamping head 13 has several movable jaws 130, in practice as many jaws 130 as there are sectors 11 in the gripper, each jaw 130 being firmly associated with a sector 11 by means of screws 6. Preferably, two 6 screws per 11 sector/jaw 130 couple.

The gripper also has a thrust pin 3 which is slidably mounted inside the body 1 along the longitudinal axis. As will be understood later, the thrust pin 3 is arranged to slide towards the second end 1b of the body 1 under the effect of an external driving force, pneumatic, hydraulic or even mechanical, depending on the tool on which the gripper is to be mounted.

The thrust pin 3 ends in a tapered thrust head 32 defining a support surface 3a inclined at an angle β with respect to the longitudinal direction of the gripper. This conical bearing surface 3a cooperates with a complementary conical bearing surface of the jaws 11 in such a way that an axial thrust of the thrust pin 3 in the direction of the housing 12 under the action of a driving force causes the sectors 11 to move apart by sliding the conical head 32 on the complementary conical bearing surface of the sectors 11.

The thrust pin 3 is also movable in the direction of the first end 1a of the body 1, under the effect of a helical spring 7, which is arranged in an axial housing 36 in the conical head 32 of the thrust pin 3 and which rests in a recess provided for this purpose in the bottom of the stud 14 at the bottom of the housing 12. The thrust pin 3 can slide between two end positions defined by stops, which a person skilled in the art can execute according to his knowledge. The spring 7 is adapted according to the tool on which the gripper is to be mounted, so that its force is less than the external driving force that the tool can exert. For example, the thrust pin 3 can be moved between:
a first end position when not subjected to an external driving force, and
a second end position when subjected to an external driving force.

In order to receive the external driving force, the thrust pin 3 is integral, by means of the oblong openings 8 of the body 1, to the thrust lugs 4 which extend outwards from the body 1. The said lugs 4 are fixed on the thrust pin 3 on flats 35 formed in the head 32 of the thrust pin 3.

In a preferred embodiment, three lugs 4 are attached to thrust pin 3 on flats 35 formed in the head of the thrust pin 3. For this purpose, the lugs 4 each have a screw tab 41 comprising a through-hole 43 for screwing a screw 5 into a complementary hole 33 of the thrust pin 3 and a tooth 42 integral with said screw tab 41 and having an external support plane inclined at an angle α with respect to a common base of the screw tab 41 and the tooth 42.

In accordance with the invention, the said lugs 4 are moreover fixed in a longitudinal and radial position on the thrust pin 4 by an fixing means such as a peg 9 driven into a blind hole 44 formed in said lugs 4 and adapted to be inserted into a hole 34 of corresponding diameter in the thrust pin 3. Preferably, said blind hole 44 for driving out the peg 9 is drilled in the tooth 42 along an axis parallel to that of the hole 43 for screwing in the tab 41 of the lugs 4.

Preferably, the fixing holes 34 and the screw holes 33 of said lugs 4 are drilled parallel to each other from the external surface of said flats 35 and open into an internal cavity of the thrust pin 3, cavity comprising in particular an axial tubing of the thrust pin 3 communicating with the housing 35 for fitting the spring 7, as visible in FIGS. 4 and 5.

This assembly of the lugs 4 in a fixed position on the thrust pin by means of a peg 9 and screws 5 provides a significant improvement and reliability of the gripper in that it guarantees, over time, an exact position of the lugs 4 at a distance d from the support collar of the sectors 11 as shown in FIG. 2. This ensures that the positioning of the lugs 4 remains constant over time, even when the gripper is dismantled and reassembled. Among other things, this permanent reference of assembly, without play, gives a precision on the machined parts held by the gripper of the invention to the order of a hundredth of a millimetre, whereas previous grippers provide at best a precision of 5 hundredths or more.

In the classical way, the lugs 4 are used to cooperate with a cylindrical spindle in which the gripper is actually mounted in use. Such a spindle has a movable socket capable of advancing towards the second end 1b of the gripper under the action of hydraulic, pneumatic or mechanical motive force transmitted by the machine tool. This socket has at least one contact area on its inner wall to cooperate with each pin 4 of the gripper. This contact zone can be straight or, advantageously, also conical, so that the contact between the zone and the lugs 4 under the action of the driving force induces a resultant tending to move the thrust pin 3 into its second end position, via each of the conical-toothed lugs.

The two end positions of thrust pin 3 are defined in such a way that:
when the thrust pin 3 is in its first end position, it does not cooperate with the tapered portion of sectors 11 of the second end 1b defining a first outside diameter,
when the thrust pin 3 is in its second end position, its head 3a rests in the conical part of the inner wall of sectors 11 of the second end 1b in such a way that these diverge to define a second outer diameter greater than the first.

Naturally, the head 13 is arranged so that it does not interfere with the movements of the thrust pin 3. The stops can be determined by the cooperation between the lugs 4 and the body 1 on either side of the openings 8.

Thanks to the connection between the sectors 11 and the jaws 130 of the clamping head 13, it is therefore possible to insert the clamping head 13 into a workpiece when the thrust pin 3 is in its first end position, since the head 13 has been appropriately dimensioned. The clamping head 13 then clamps the workpiece from the inside by moving the thrust pin 3 to its second end position under the effect of an external driving force. When the driving force for actuating the thrust pin is stopped, the thrust pin returns under the restoring force of spring 7 and the sectors 11 of the gripper and jaw 130 of the head 13 return elastically to their rest position. The workpiece can therefore be removed from the clamping head 13.

The gripper according to the invention therefore makes it very easy to change the clamping head for various tasks. Furthermore, it adapts to a standard machine without having to modify or adapt the spindle. It is even possible to change the head without having to remove the grippers from the tool. This saves a lot of time, especially when adjusting and calibrating the tool. This type of gripper therefore offers high precision and very good rigidity in holding the workpiece, while allowing the workpiece to be machined along its entire length, without having to change machines or modify the gripping of the workpiece.

1. Gripper with interchangeable head comprising:
a body (1) defining a longitudinal axis, comprising a first end (1a) intended to be fitted into a nut (2) and a second, free end (1b) provided with sectors (11) capable of elastic deformation in a radial direction and intended to receive a removable head,
a thrust pin (3) mounted to slide along said longitudinal axis inside said body (1), in a first direction under the effect of a driving force transmitted through the nut by a kinematic connection means and in a second direction under the effect of a spring member (7),
a plurality of lugs (4) mounted integrally and in a regular angular arrangement on the thrust pin (3) and protruding radially from the surface of said thrust pin through the body (1) of the gripper, wherein said lugs (4) are fixedly arranged in a longitudinal and radial position on the thrust pin (4) by a fixing means (9).

2. The gripper according to claim 1, wherein said body (1) comprises oblong openings (8) through which the lugs (4) extend protruding from the thrust pin (3).

3. The gripper according to claim 1, wherein the fixing means is a peg (9) driven into a blind hole (44) formed in said lugs (4) and adapted to be inserted into a hole (34) of corresponding diameter in the thrust pin (3).

4. The gripper according to claim 1, wherein the said sectors delimit a cradle for the play-free mounting of a gripper's head comprising deformable sectors capable of being secured to the sectors of the body (1) of the gripper by screwing.

5. The gripper according to claim 1, wherein the said lugs (4) are fixed on the thrust pin (3) on flats (35) formed in the head of the thrust pin (3).

6. The gripper according to claim 1, wherein the said lugs (4) are locked in rotation on the thrust pin (3) by screwing into a hole (33) drilled in the said thrust pin (3).

7. The gripper according to claim 3, wherein the fixing holes (34) and the screwing holes (33) of said lugs (4) are drilled parallel to each other from an external surface of said flats (35), and open into an internal cavity of the thrust pin (3).

8. The gripper according to claim 3, wherein the said lugs (4) comprise a screw tab (41) comprising a through-hole (43) for screwing on the thrust pin (3) and a tooth (42) integral with said screw tab (41) and having an external support plane inclined at an angle (α) with respect to a common base of the screw tab (41) and the tooth (42).

9. The gripper according to claim 8, wherein the said blind hole (44) for driving in the peg (9) is drilled in the tooth (42) along an axis parallel to that of the screwing hole (43).

10. The gripper according to claim 4, the mounting cradle for the removable head delimited by the sectors of the body comprises a flat internal guide surface and the removable head comprises a mounting sleeve with a flat external surface and a diameter equal to the internal diameter of the mounting cradle.

11. Machining device comprising a gripper with an interchangeable head according to claim 1.

12. The gripper according to claim 2, wherein the fixing means is a peg (9) driven into a blind hole (44) formed in said lugs (4) and adapted to be inserted into a hole (34) of corresponding diameter in the thrust pin (3).

13. The gripper according to claim 2, wherein the said sectors delimit a cradle for the play-free mounting of a gripper's head comprising deformable sectors capable of being secured to the sectors of the body (1) of the gripper by screwing.

14. The gripper according to claim 3, wherein the said sectors delimit a cradle for the play-free mounting of a gripper's head comprising deformable sectors capable of being secured to the sectors of the body (1) of the gripper by screwing.

15. The gripper according to claim 2, wherein the said lugs (4) are fixed on the thrust pin (3) on flats (35) formed in the head of the thrust pin (3).

16. The gripper according to claim 3, wherein the said lugs (4) are fixed on the thrust pin (3) on flats (35) formed in the head of the thrust pin (3).

17. The gripper according to claim 4, wherein the said lugs (4) are fixed on the thrust pin (3) on flats (35) formed in the head of the thrust pin (3).

18. The gripper according to claim 2, wherein the said lugs (4) are locked in rotation on the thrust pin (3) by screwing into a hole (33) drilled in the said thrust pin (3).

19. The gripper according to claim 3, wherein the said lugs (4) are locked in rotation on the thrust pin (3) by screwing into a hole (33) drilled in the said thrust pin (3).

20. The gripper according to claim 4, wherein the said lugs (4) are locked in rotation on the thrust pin (3) by screwing into a hole (33) drilled in the said thrust pin (3).
